(19) United States
(12) Patent Application Publication
(10) Pub. No.: US 2023/0236548 A1
(43) Pub. Date: Jul. 27, 2023

(54) ENCASEMENT FOR A WATCH

(71) Applicant: STM Management Pty Ltd, Alexandria NSW (AU)

(72) Inventors: Ethan NYHOLM, Bondi Beach NSW (AU); Scott STROHMAN, San Diego, CA (US); Jacob GOODRIDGE, Kelvin Grove QLD (AU)

(21) Appl. No.: 17/678,818

(22) Filed: Feb. 23, 2022

Related U.S. Application Data
(63) Continuation of application No. 29/826,254, filed on Feb. 10, 2022.

(30) Foreign Application Priority Data
Jan. 21, 2022 (AU) 202210434

(51) Int. Cl. G04B 37/00

(52) U.S. Cl. CPC G04B 37/0008

(57) ABSTRACT

Disclosed herein is an encasement for a watch.

### PRIORITY CLAIM

The present application is a continuation of U.S. Design patent application No. 29/826,254, filed Feb. 10, 2022, which claims priority to Australian Patent Application No. 202210434, filed on Jan. 21, 2022, the disclosures of which are hereby incorporated by reference herein in their entirety.

### TECHNICAL FIELD

The disclosure herein generally relates to an encasement for a watch.

### BACKGROUND

Examples of watches include but are not limited to wrist watches including an Apple Watch™, a Samsung Galaxy Watch™, a Fitbit™, and pocket watches.

An owner of a watch may wish to protect it. For example, an outdoor adventurer may wish to prevent damaging contact between the watch and a rock. A construction worker may wish to prevent contact between the watch and hardware or another object. An owner of a valuable or delicate watch may desire to protect their watch even in less tough environments, for example home and office environments.

An owner of a watch may wish to change the outward appearance of the watch.

### SUMMARY

Disclosed herein is an encasement for a watch. The encasement comprises a watch receiving body for receiving the watch. The encasement comprises a closure removably fastenable to the watch receiving body and which cooperates therewith to define a protected watch receiving cavity.

In an embodiment, the closure comprises a protective perimeter wall and a watch face viewing window interior of the protective perimeter wall. The closure may comprise a securing lip that is inwardly directed, and an outward surface of the watch receiving body defines a securing grove configured to receive therein the securing lip. The protective perimeter wall may define a port for a control of the watch. The protective perimeter wall may comprise a watch control actuator for actuation of a control of the watch. The watch control actuator may comprise an operable button.

In an embodiment, the watch receiving body comprises a closure fastener. The closure fastener may comprise a hook defining a throat in which is receivable the protective perimeter wall.

In an embodiment, the closure comprises a plurality of watch keys for receipt by a plurality of cavities defined by the watch. The watch keys may inwardly depend from the closure.

An embodiment comprises a stowable watch face protective strap that is fastenable across the watch face viewing window. The embodiment may comprise a stowable protective strap catch for reversably fastening the stowable protective strap across the watch face viewing window. The embodiment may comprise a bracelet configured to engagingly stow the stowable protective strap. The bracelet may comprise another stowable protective catch for reversibly catching a distal end of the stowable protective strap. The bracelet may comprise a stowable protective strap receiving recess. A proximal end of the protective strap may be pivotably attached to the bracelet.

Any of the various features of each of the above disclosures, and of the various features of the embodiments described below, can be combined as suitable and desired.

### BRIEF DESCRIPTION OF THE FIGURES

Embodiments will now be described by way of example only with reference to the accompanying figures in which:

FIG. 1 is a isometric view of an encasement for a watch.

FIG. 2 is a front elevational view of the encasement of FIG. 1.

FIG. 3 is a plan view of the encasement of FIG. 1, showing the top thereof.

FIG. 4 is a bottom view of the encasement of FIG. 1, showing a bottom thereof.

FIG. 5 is a left-side elevational view of the encasement of FIG. 1.

FIG. 6 is a right-side elevational view of the encasement of FIG. 1.

FIG. 7 is an isometric view of a closure of the encasement of FIG. 1.

FIG. 8 is another isometric view of the closure of FIG. 7.

FIG. 9 is an isometric view of the encasement of FIG. 1 with the closure removed.

FIG. 10 is an isometric view of a watch face protector of the encasement of FIG. 1.

FIG. 11 a plan view of the encasement in which is received a watch, with a watch face protector disposed over the face of the watch.

FIG. 12 is a side view of a watch receivable by the encasement, with an arm of a watch band removed.

FIG. 14 is an exploded isometric view of another embodiment of an encasement for a watch and a watch.

FIG. 15 is an isometric view of the encasement of FIG. 14 with a closure separated from a watch receiving body in which the watch is secured.

FIGS. 15 to 18 show isometric detail views of the encasement of FIG. 14 with a watch face protector disposed over the face of the watch, in which is visible a stowable watch face protector strap receiving recess of a watch bracelet.

### DESCRIPTION OF EMBODIMENTS

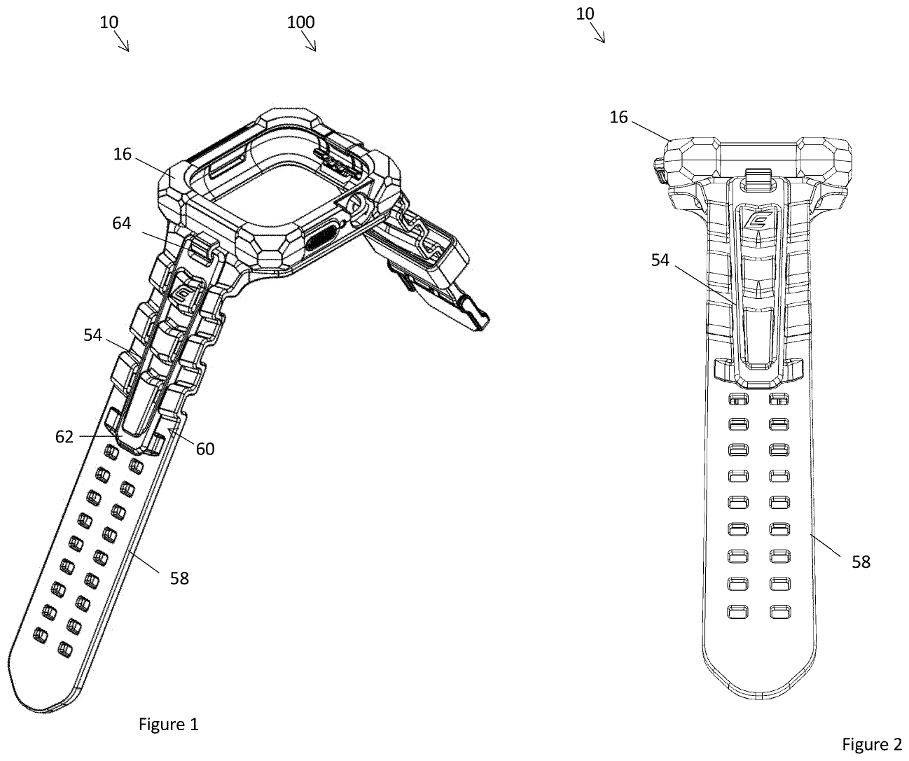

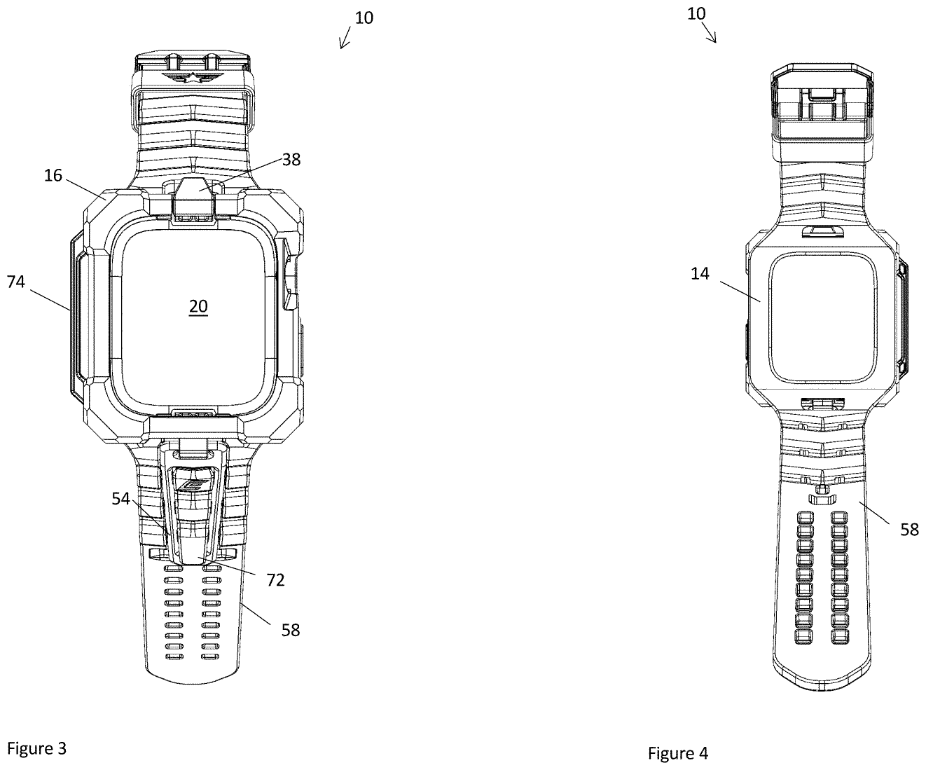

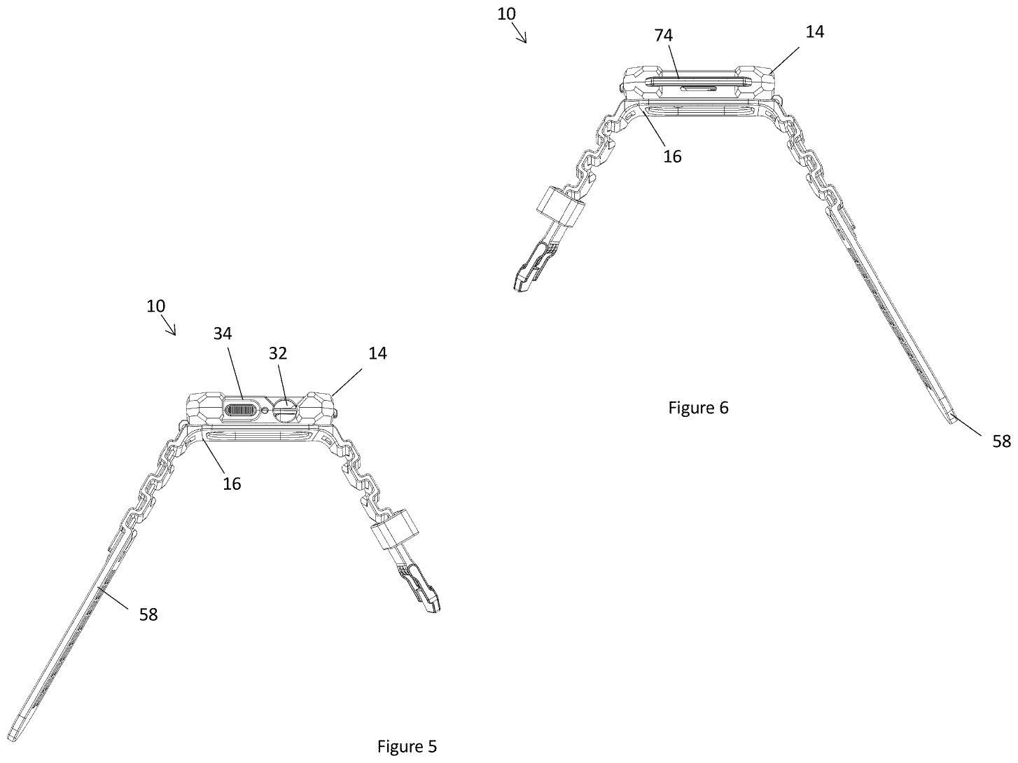

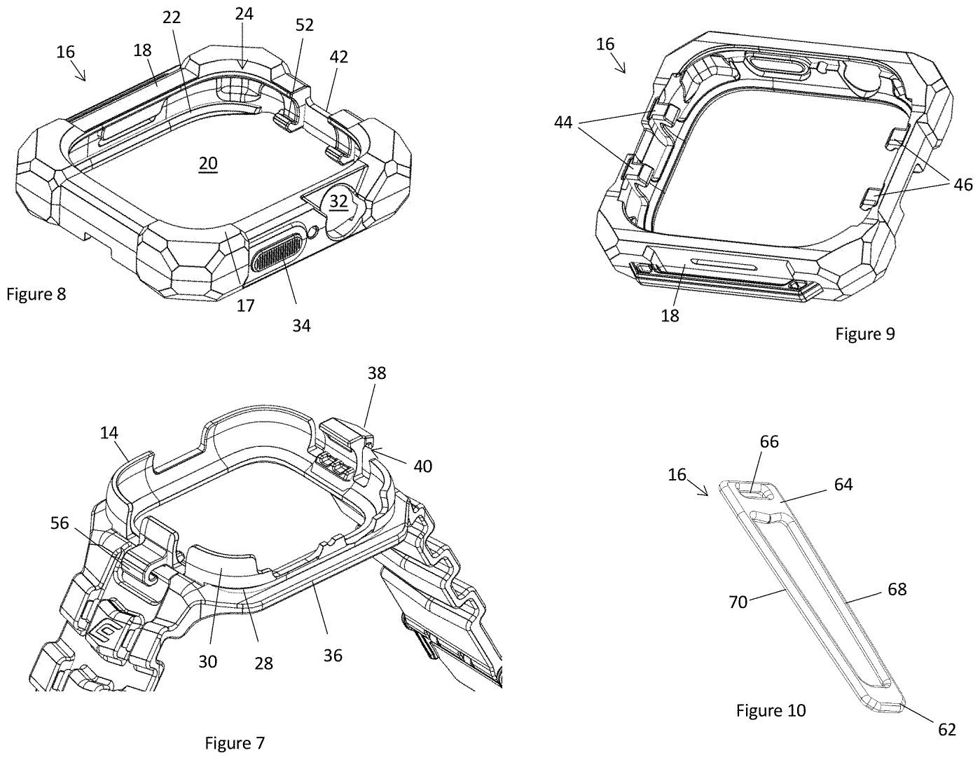

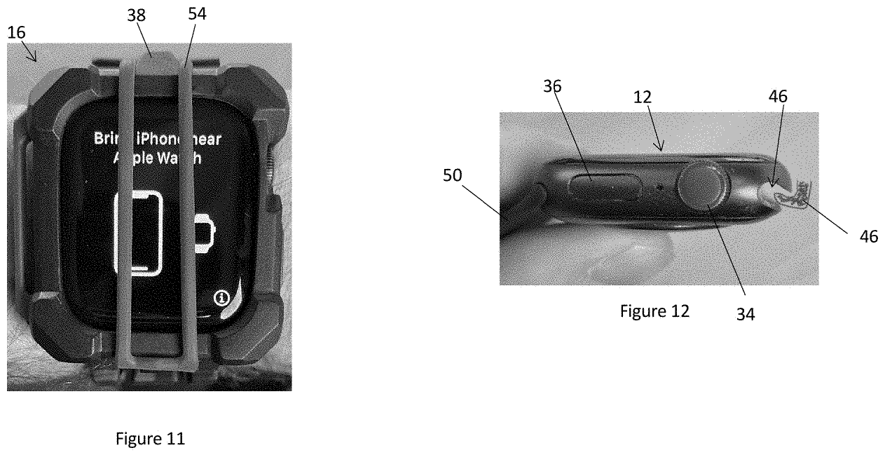

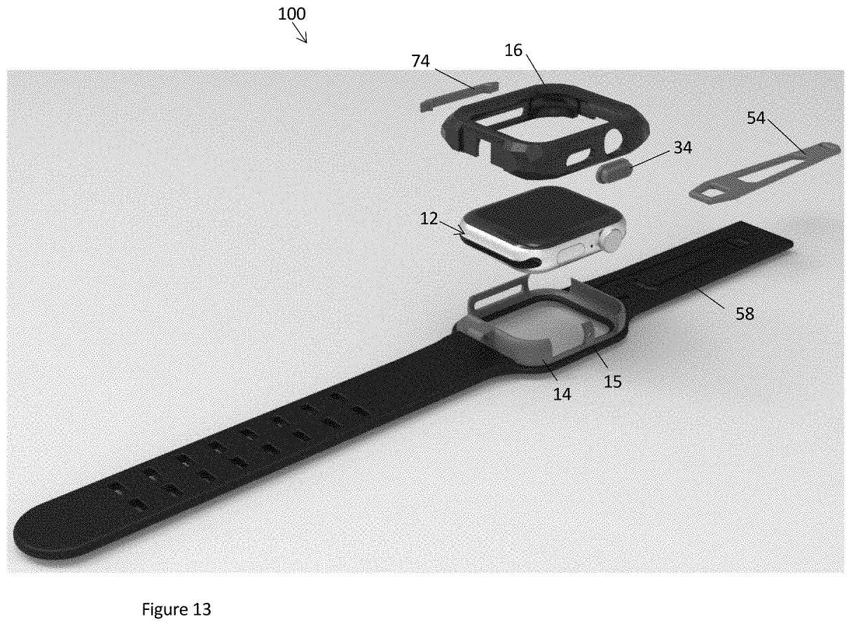

FIGS. 1 through 11 show various views of an embodiment of an encasement for a watch, generally indicated by the numeral 10. This but not all embodiments are for a watch in the form of an Apple Watch™, a side view of which is shown in FIG. 12 and indicated by numeral 12. The encasement 10 comprises a square watch receiving body 14 for receiving the watch 12. The encasement 10 comprises a square closure 16 shown in FIGS. 8 and 9 removably fastenable to the watch receiving body 14. The closure 16 and the watch receiving body 14 cooperate to define a protected watch receiving cavity in which the watch can be protectively received.

The closure 16 comprises a protective perimeter wall 18. The protective perimeter wall 18 is attached to a face portion 17 of the closure 16, the face portion being at the face of the watch 12 when within the encasement. A watch face viewing window 20 is interior of the protective perimeter wall 18. The protective perimeter wall—especially the corners thereof—are raised to protect the face of the watch.

The closure 16 comprises a securing lip 22 at a bottom-side thereof. The securing lip 22 is inwardly directed, and extends past adjacent corners including corner 24. An outward surface 26 of the watch receiving body 14 defines a securing grove similar or identical to securing groove 28, configured to receive therein the securing lip 22, and so secure the closure 16 to the watch receiving body 14. The closure 16 comprises resilient material, and is stretched during the insertion of the securing lip 22 into the securing groove, and then returns to its unstretched state when the securing lip 22 is received by the securing groove. Another securing lip—obstructed from view in the figures—extends from the opposite side of the closure 22 and is received by securing groove 28.

The watch receiving body 14 comprises an inner protective perimeter wall 30 that is sleeved within the outer protective perimeter wall 18 of the closure 16. The inner protective perimeter wall 30 is attached to a base portion 36 of the watch receiving body 14. The inner protective perimeter wall 30 defines an inwardly facing concavity, in which a distal end of the inner protective perimeter protective wall 30 is curved inwardly, and the proximal end thereof of perpendicular to the base 15 of the watch receiving body. The watch 12 can be inserted within the resilient concave inner protected perimeter wall 30, which captures the watch 12 within the concavity and holds it to the watch receiving body 14. The resilient concave inner protective wall 30 resiliently deforms to allow passage of the watch 12.

The protective perimeter wall 18 defines a port 32 for a control 34 of the watch 12. The protective perimeter wall 18 also comprises a watch control actuator 34 in the form of an operable button for actuation of another control 36 of the watch 12.

The watch receiving body 14 comprises a closure fastener in the form of a hook 38. The hook 38 defines a throat 40 in which is received a reduced portion 42 of the protective perimeter wall 18. The hook 38 captures the reduced portion 42 to hold the closure 16 to the base 36.

The closure 16 comprises a plurality of resilient watch keys 44, 46 for receipt by a plurality of cavities—for example cavity 48—defined by the watch 12. The cavity 48 is for capturing a removable watch band, similar to watch band 50 but is used here for a different purpose. The watch keys 44, 46 inwardly depend from the closure 16. The watch keys 44, 46 secure the closure 16 to the watch, which is independently secured to the watch receiving body 14. The resilient watch keys 44, 46 resiliently deform, bending topwardly at a flexure in the form of a living hinge 52, during entry into the cavity 48 of the watch 12.

The encasement 10 comprises a stowable protective strap 54. The protective strap 54 is fastenable across the watch face viewing window 20.

The encasement 10 comprises a bracelet in the form of a watch band 58 attached to the watch receiving body 14, and to which the protective strap 54 is pivotably attached. The bracelet 58 is attached at a back of the watch receiving body 14, and the closure 16 is at the front of the watch receiving body 14. The watch band 58 is configured to engagingly stow the stowable protective strap, defining a stowable protective strap receiving recess 60. The protective strap 54 comprises a proximal end portion 64 and a distal end 62 portion each attached to longitudinal protective strap members 68, 70.

The bracelet 58 comprises a stowable protective catch in the form of hook 38 for reversibly catching a distal end 62 of the stowable protective strap 54. Another stowable protective strap catch 64 in the form of another hook to one side of the closure 16 catches the proximal end 64. The proximal end 64 of the stowable protective strap 54 defines a catch receiving aperture 66 for receiving catch 64. Yet another catch 72 defines a cavity for receiving the distal end of the stowable protective strap.

The encasement 10 has a webbing attachment device 74 for attaching an item to webbing in the form of military webbing, for example Modular Lightweight Load-carrying Equipment (MOLLE). The webbing attachment device 74 is in the form of a loop laterally depending from the enclosure 1.

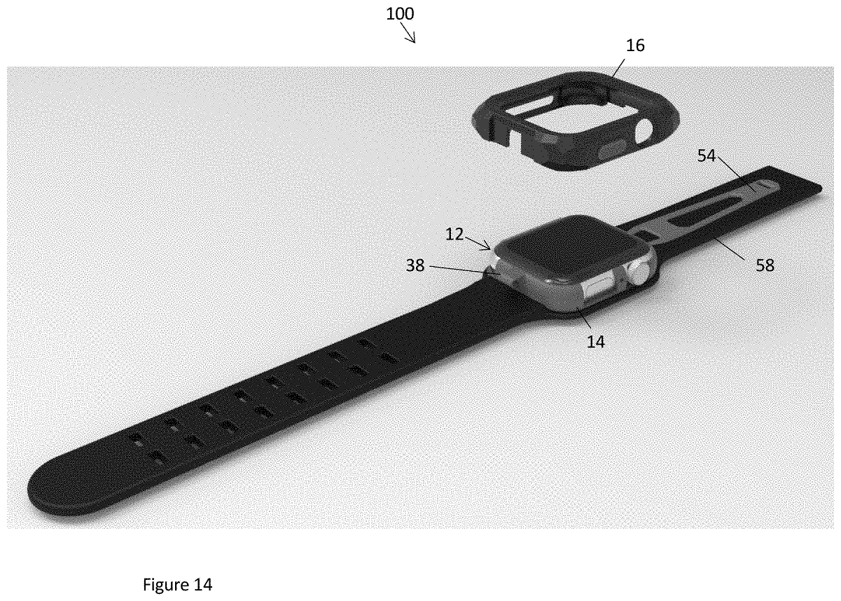

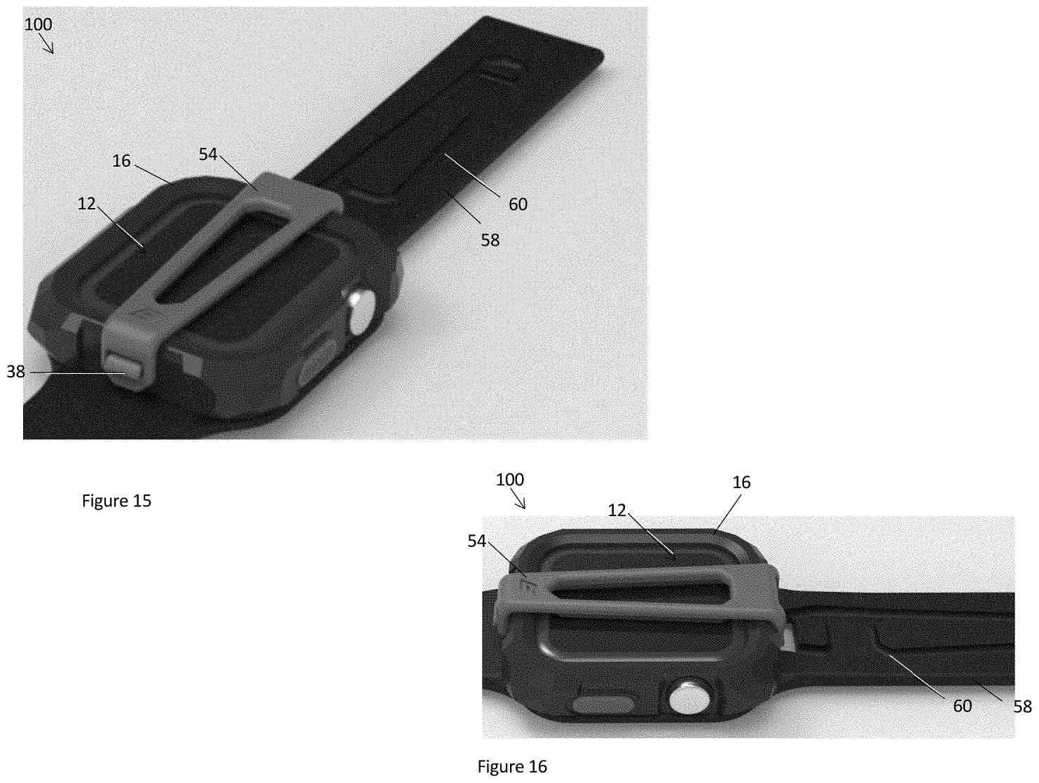

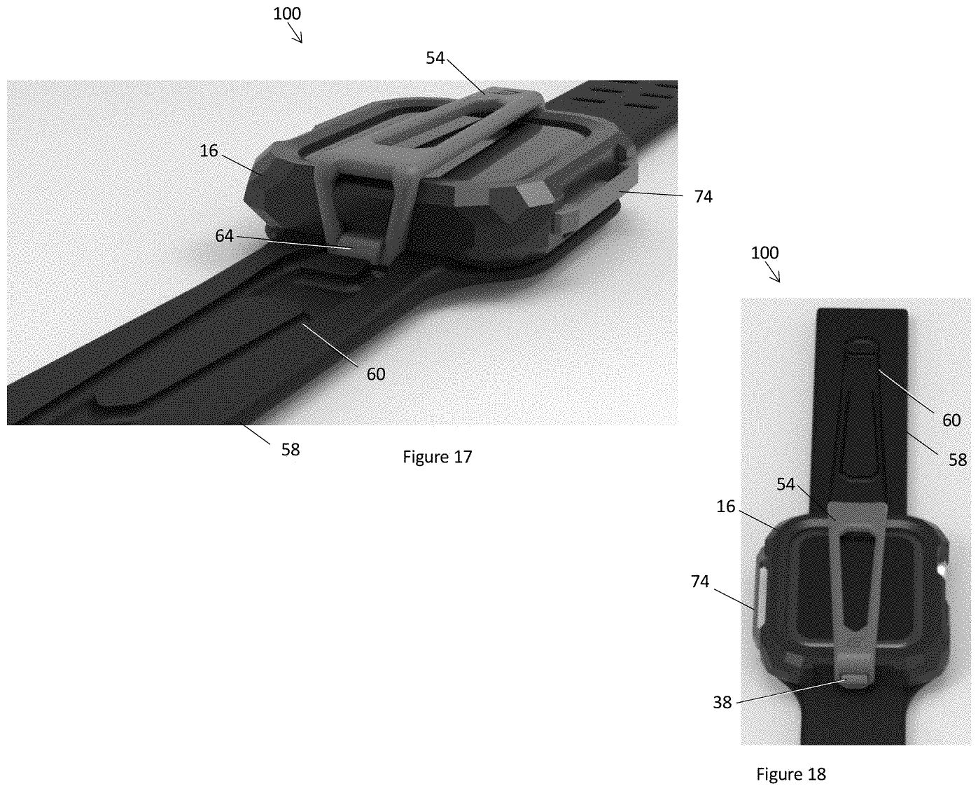

FIGS. 13 to 18 show various views of another embodiment of an encasement for a watch 100, where parts similar or identical in form and/or function to those shown in FIGS. 1 to 12 are similarly numbered.

Now that embodiments have been described, it will be appreciated that some embodiments may have some of the following advantages:
The watch may be protected from damaging contact
The appearance of the watch may be changed by selecting a different encasement.
The inner and outer protective perimeter walls may provide further protection to the watch.
The protective strap may be less likely to snag when stowed.
The watch may be relatively easily removed.
The watch face may be protected.

Variations and/or modifications may be made to the embodiments described without departing from the spirit or ambit of the invention. For example:
Embodiments may be configured for a watch other than the Apple Watch™, examples of which include but are not limited to the Samsung Galaxy Watch™, a Fitbit™, and pocket watches.
The watch receiving body and enclosure may have a round or generally any suitable shape.
The webbing attachment device may be attached to the bracelet or the watch receiving body.

The present embodiments are, therefore, to be considered in all respects as illustrative and not restrictive. Reference to a feature disclosed herein does not mean that all embodiments must include the feature.

Prior art, if any, described herein is not to be taken as an admission that the prior art forms part of the common general knowledge in any jurisdiction.

In the claims which follow and in the preceding description of the invention, except where the context requires otherwise due to express language or necessary implication, the word “comprise” or variations such as “comprises” or “comprising” is used in an inclusive sense, that is to specify the presence of the stated features but not to preclude the presence or addition of further features in various embodiments of the invention.

1. An encasement for a watch comprising:
a watch receiving body for receiving the watch; and
a closure removably fastenable to the watch receiving body and which cooperates therewith to define a protected watch receiving cavity.

2. An encasement defined by claim 1 wherein the closure comprises a protective perimeter wall and a watch face viewing window interior of the protective perimeter wall.

3. An encasement defined by claim 2 wherein the closure comprises a securing lip that is inwardly directed, and an outward surface of the watch receiving body defines a securing grove configured to receive therein the securing lip.

4. An encasement defined by claim 2 wherein the protective perimeter wall defines a port for a control of the watch.

5. An encasement defined by claim 2 wherein the protective perimeter wall comprises a watch control actuator for actuation of a control of the watch.

6. An encasement defined by claim 5 wherein the watch control actuator comprises an operable button.

7. An encasement defined by claim 1 wherein the watch receiving body comprises a closure fastener.

8. An encasement defined by claim 7 wherein the closure fastener comprises a hook defining a throat in which is receivable the protective perimeter wall.

9. An encasement defined by claim 1 wherein the closure comprises a plurality of watch keys for receipt by a plurality of cavities defined by the watch.

10. An encasement defined by claim 9 wherein the watch keys inwardly depend from the closure

11. An encasement defined by claim 1 comprising a stowable watch face protective strap that is fastenable across the watch face viewing window.

12. An encasement defined by claim 11 comprising a stowable protective strap catch for reversably fastening the stowable protective strap across the watch face viewing window.

13. An encasement defined by claim 11 comprising a bracelet configured to engagingly stow the stowable protective strap.

14. An encasement defined by claim 13 wherein the bracelet comprises another stowable protective catch for reversibly catching a distal end of the stowable protective strap.

15. An encasement defined by claim 13 wherein the bracelet comprises a stowable protective strap receiving recess.

16. An encasement defined by claim 11 wherein a proximal end of the protective strap is pivotably attached to the bracelet.

17. An encasement defined by claim 1 comprising a bracelet attached to the watch receiving body.

18. An encasement defined by claim 17 wherein the bracelet is attached at a back of the watch receiving body and the closure is at the front of the watch receiving body.
